(19) United States
(12) Patent Application Publication
(10) Pub. No.: US 2018/0370321 A1
(43) Pub. Date: Dec. 27, 2018

(54) Automotive Air Conditioning Service Kit

(71) Applicant: Omega Acquisition Corp, Irving, TX (US)

(72) Inventors: Earl Bloom, Plano, TX (US); Tommy France, Grapevine, TX (US); Cristin Heilker, Arlington, TX (US); Mike Mcdaniel, Keller, TX (US)

(21) Appl. No.: 15/630,682

(22) Filed: Jun. 22, 2017

(51) Int. Cl. B60H 1/00; F24F 13/14; F16L 17/08

(52) U.S. Cl. CPC B60H 1/005; B60H 1/00571; G01F 19/00; F16L 17/08; F24F 13/1406

(57) ABSTRACT

An Air Conditioning Service kit and method for producing the same, wherein the kit contains a compatible selection of the most commonly needed parts for servicing the air conditioner in a vehicle or consolidated group of vehicles including one or more Expansion Devices, an Accumulator or Receiver Dryer, a Lubricant Oil such as compressor PAG oil, A Measuring Cup, and a Rapid Seal Kit.

### BACKGROUND OF THE INVENTION

### Field of the Invention

The present invention relates to the field of vehicles and more particularly, to automotive air conditioning systems and related methods.

### Background of the Invention

Air conditioning systems contain a set of component parts which transfer and circulate refrigerant through the system in liquid and vapor forms, and control refrigerant pressure during use. These components are subject to wear and tear, and occasionally need servicing. In order to service the system, mechanics must purchase the required parts compatible with the system being serviced. As air conditioning systems use different components depending on the make and model of vehicle being repaired, keeping compatible versions of all required parts on hand may be impractical. The mechanic may diagnose the problem with the vehicle and order the required component to repair the AC system, but accurate diagnosis of a problem may require compatible replacement parts on hand for testing, and ordering parts after already diagnosing the problem causes further delays while the appropriate part is shipped.

Similarly, auto parts stores which distribute parts for repairs to mechanics must also keep an up to date stock of the component parts for purchase or be able to ship them quickly to the location on demand. A private individual with knowledge of how to perform repairs has a need for a set of compatible parts for their vehicle consolidated in a single kit in order to feasibly perform repairs on their own without spending long periods of time on research and locating suppliers for individual parts, or mistakenly purchasing an incompatible part. As such, there is a need for replacement part kits for vehicles which contains the frequently required parts for regular repairs and maintenance of an AC system. This would allow mechanics and private individuals to order all parts likely to be used for testing and repair in advance, and allowing the mechanic to forego searching for a list of compatible parts servicing the vehicle.

A compressor box kit currently being sold by the company includes the parts typically used when replacing a compressor. The kit includes a new compressor, a drier or accumulator, an expansion device, a lubricant oil, and a rapid seal kit; each of which is compatible with the make, model, and year of the vehicle undergoing repairs. While a service kit of this variety is useful when the compressor needs to be replaced, compressors are one of the most expensive parts to replace in an AC system, are bulky enough to occupy a large volume of storage space in comparison to other commonly used parts, and vary widely between vehicles. This means that by removing the compressor from the kit elements a set of consolidations may be performed which reduces the number of kits required to service all vehicles.

In addition, while compressors may need regular servicing, a well maintained compressor may often last the life of the vehicle before requiring replacement. In contrast, other parts such as expansion devices, accumulators, or receiver dryers, and lubricant oil need regular replacement to ensure efficient functioning of the system. As such, a mechanic looking to maintain a stock of replacement parts on hand may be reluctant to purchase a full set of compressor box kits, as this will require purchasing a large number of kits containing expensive compressors in advance, and then setting aside the space to store these compressors in the shop. In addition to potential storage issues and the expense of the compressors themselves, maintaining a separate kit for each variety of compressor results in the mechanic keeping many redundant parts on hand, while requiring the mechanic to track a corresponding number of stock keeping units to track their inventory.

Adding to the potential redundancy in inventory, the parts included in the compressor box kit are necessary to have on hand when replacing a compressor. A mechanic wanting to use a part from the kit for more routine maintenance must choose between breaking apart the compressor box kit for a relatively inexpensive repair, ordering the parts for routine maintenance separately, or ordering new individual parts to replace the parts removed from the kit to carry out the repair. For example, whenever the AC system is opened up for repairs it is generally necessary to replace the accumulator or receiver dryer in order to remove moisture and contaminants that have entered from the environment while the system is open. In the case of a compressor failure, the filters will likewise need to be replaced in order to remove any metal bits such as broken pieces of piston ring which have entered the system, and in orifice tube systems the orifice tube's in line filter is likely to become clogged with debris.

This means that if the mechanic uses an accumulator and orifice tube or a receiver dryer from the compressor box kit to make routine repairs, they must order a replacement in order for the kit to be useable in its intended function to replace a compressor. If mechanics do not want to break up their compressor repair kits for more routine maintenance, mechanics must either maintain a separate redundant supply of replacement parts for routine maintenance, which may require identifying and ordering the compatible parts individually, or they must track their stock of incomplete or partially used kits in order to replace or combine them. Both options increase the time and resources that must be devoted to inventory management, and increases the likelihood that the mechanic will not have the proper parts on hand when they are needed.

Due to the inefficiencies of currently existing repair and service kits as described above, there is a need for a kit which consolidates the parts required to perform repairs and maintain the air conditioning systems of multiple vehicles in order to simplify inventory management and reduce expenses. Ideally the service kits should be consolidated by identifying and grouping multiple makes and models of vehicle containing similar replacement parts into kits in order to minimize the number of stock keeping units (SKU's) and storage space required to maintain a supply of parts for commonly serviced vehicles.

### BRIEF DESCRIPTION OF THE DRAWINGS

FIG. 1 shows an example automotive air conditioning system identifying key components of interest.

FIG. 2. shows an example AC Service Kit for a vehicle or set of vehicles in accordance with a preferred embodiment of the invention.

### SUMMARY OF THE INVENTION

In order to service an air conditioning system in a vehicle, a mechanic will need one of a selection of parts. An object of the present invention is to provide a compatible selection of the most commonly needed parts for servicing the air conditioner in a vehicle or consolidated group of vehicles, while omitting parts which would be too bulky or expensive to order or which do not commonly malfunction. In a preferred embodiment, the kit includes: One or more Expansion Devices, an Accumulator or Receiver Dryer, a Lubricant Oil such as compressor PAG oil, A Measuring Cup, and a Rapid Seal Kit. Other embodiments may omit the Compressor Oil or Measuring Cup.

Another object of the present invention is to provide air conditioning service kits which consolidate vehicles by make, model, and year into a plurality of groups containing vehicles which share many compatible parts. This minimizes the space and number of stock keeping units required to keep parts on hand, as the mechanic does not need to maintain a stockpile of parts for each individual vehicle.

### DETAILED DESCRIPTION

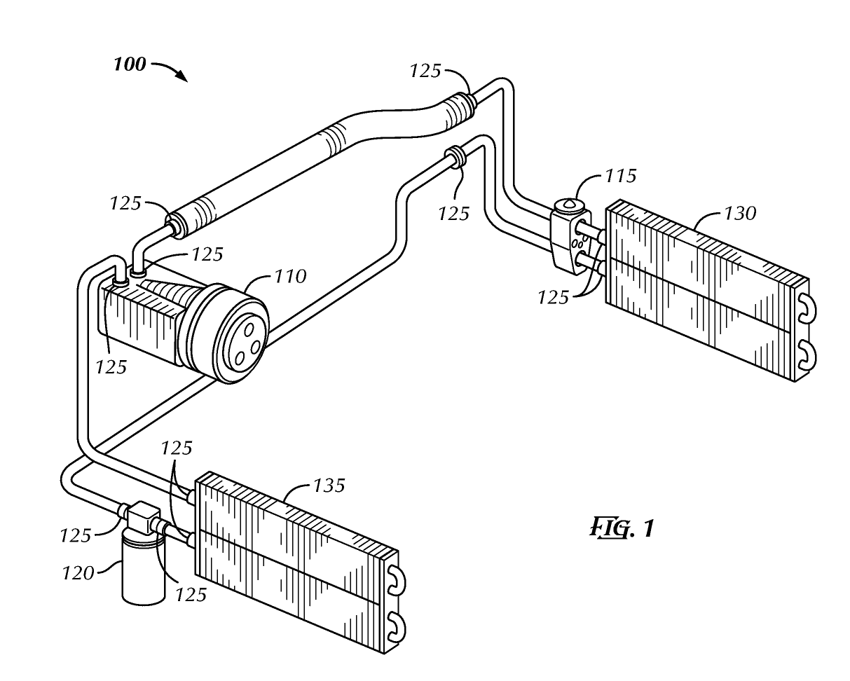

FIG. 1 shows an example automotive air conditioning system 100 identifying key components of interest. The AC system 100 generates cool air by circulating a refrigerant through the system in liquid and vapor form. The compressor, 110 typically powered by a drive belt attached to the engine, pressurizes the system and pumps vaporized refrigerant released from the evaporator 130 to the condenser 135. In the condenser 135, the refrigerant is pumped at high pressure through a coil adjacent to a fan, which draws air from outside the vehicle over the condenser coil. Due to a combination of pressure from being pumped through the compressor 110 and heat transfer from the coil to the air, the refrigerant converts from a vapor to a liquid form.

In systems using an expansion valve as the expansion device 115, the liquid refrigerant exiting the condenser 135 is collected in a reservoir called the receiver dryer 120, where it is filtered to remove contaminants such as moisture. In systems using an orifice tube as the expansion device 115, the system collects and filters refrigerant in a similar device known as an accumulator instead when the refrigerant leaves the evaporator 130. Once the cooled liquid refrigerant leaves the condenser 135, it is pumped through an expansion device 115.

The expansion device 115 may be an orifice tube or an expansion valve depending on the design of the AC system 100. In either case, the expansion device 115 converts the refrigerant from a liquid into a gas by controlling how much refrigerant flows out of the valve. Since the size of the opening is generally much smaller than the pipe through which the refrigerant is pumped into the valve, the refrigerant expands in volume and cools as it is released from the expansion device 115 into the evaporator 130.

In the evaporator 130, the cooled refrigerant vapor is sent through a set of coils similar to those found in the condenser 135. A fan blows air over the chilled evaporator coils and into the passenger compartment of the vehicle, cooling the vehicle. In some vehicles, the AC system includes a front and rear expansion device 115 and evaporator 130, with the second evaporator 130 typically releasing cool air into the passenger or rear seats of the car. These vehicles require multiple expansion devices 115 when they are serviced, which are included in the service kit. In some vehicles, the front and rear expansion devices 115 are different from one another. The rear expansion devices 115 are typically expansion valves, even in systems with an accumulator 225 which use orifice tubes as their forward expansion device 115.

Since leaks of refrigerant or contaminants such as moisture entering from the outside can degrade the AC system 100, joints and connections within the system are secured with a plurality of seals 125. These seals 125 are often O-rings of varying size and thickness, and one vehicle often contains many different varieties of seals 125.

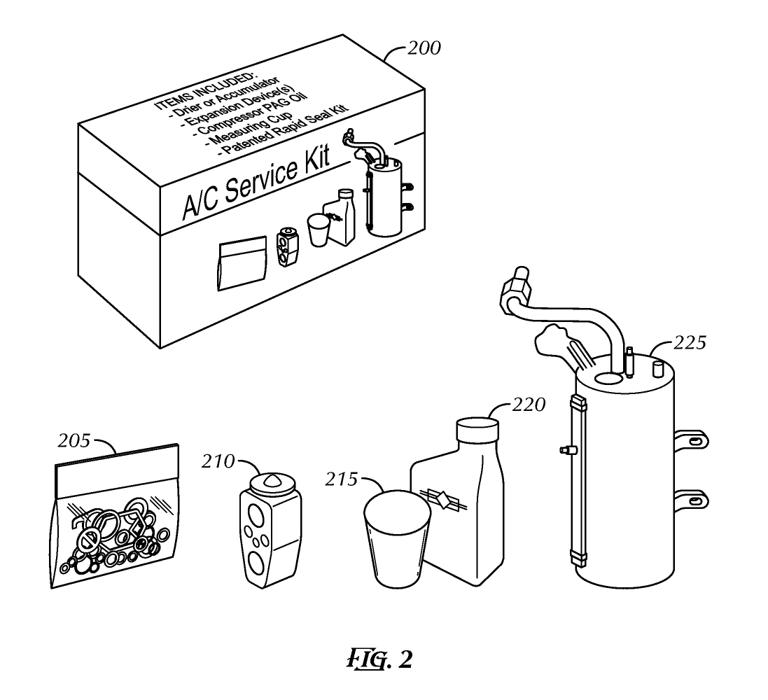

FIG. 2. shows an example AC Service Kit 200 for a vehicle or set of vehicles in accordance with a preferred embodiment of the invention. The AC Service Kit 200 contains one or more expansion devices 205, an accumulator or receiver dryer 225, a lubricant oil 220, a measuring cup 215, and a rapid seal kit 205. Each of these components is frequently needed when servicing an air conditioner for a vehicle. Each kit is designed to provide the required materials to service an air conditioner for a vehicle or set of vehicles sorted by their make, model, and year into groupings sharing many compatible parts.

Expansion devices 210 such as orifice tubes and expansion valves need to be serviced when they become blocked by dirt or debris or corroded by moisture. Orifice tubes contain an inlet screen just before the orifice which acts as a filter or sieve in order to catch debris such as dirt, metal filings, or broken pieces of piston rings from a compressor failure before they enter into the evaporator. When the filter is blocked, the entire orifice tube must usually be replaced. Expansion valves may become stuck in place if exposed to moisture. or may similarly become clogged with debris. When this occurs, the pressure within the system is no longer controlled reliably by the expansion device 210.

When the system is opened up for servicing, the accumulator or receiver dryer 225 will often need replacement due to its key role in filtering moisture and contaminants from the system. Receiver dryers contain a filter to catch debris, which may be blocked by debris. In both systems, moisture is filtered out of the refrigerant or oil using desiccant which is contained in the accumulator or receiver dryer 225. If all the desiccant is consumed, the accumulator or receiver dryer 225 will be unable to trap moisture, causing corrosion. Additionally, mechanics often recommend replacing the accumulator or receiver dryer 225 after accidents, major part replacements, or any other time that the system is opened and exposed to the environment, since this will lead to additional moisture and contaminants entering the system.

When properly distributed through the system, lubricant oil 220 allows all parts to move smoothly, helps seal the system against air leakage, and removes heat generated by the compressor 110. If the compressor 110 operates at a high heat for too long a time, it can result in an oil failure which requires replacement of contaminated parts, so it is important to ensure the system contains the proper quantities of lubricant oil 220 and that the oil is in good operating condition. The lubricant oil 220 is designed to be compatible with and circulate in combination with the refrigerant used in the vehicle. The three commonly used refrigerants are R12, R134, and RF1234. In one embodiment, the kit also includes a measuring cup 215 used to measure out the required quantity of lubricant oil 220 when servicing the system. The corresponding lubricant oils 220 are mineral oil, polyalkylene glycol oil (PAG oil), and polyolester oil (POE oil). Different vehicles may use the same variety of lubricant oil 220 at varying viscosities.

The rapid seal kit 205 is used to replace any leaking or damaged seals when servicing the AC system. The rapid seal kit 205 is a consolidated set of seals for replacement of seals for multiple vehicles with different make, model, or year. In general, consolidated rapid seal kits are produced by preparing a database of what seals are typically required to service the AC systems of the plurality of different vehicles, determining sets of vehicles that contain many seals in common, preparing seal kit corresponding to each grouping of vehicles with seals in common which contains the set of seals needed to service each group of vehicles, and creating a database of which vehicles correspond to which seal kits by make, model, and year. In some cases, the rapid seal kits may contain multiple replacements for each type of seal, or may offer only the seals which commonly need replacement. The rapid seal kit 205 is described in detail in the previously issued U.S. Pat. Nos. 7,325,809, 7,503,103, and 7,574,847 which, by this statement, are incorporated herein by reference. The rapid seal kit 205 is defined for the purposes of this application as being any kit claimed in the three referenced patents or produced by a method claimed in the three referenced patents.

In order to reduce the number of kits required to maintain a stock of parts for repair, the AC service kits may be consolidated by make, model, and year of the vehicle such that a single kit includes compatible parts to service multiple vehicles which share many parts in common. In order to consolidate the kits, a list is prepared of the component parts for each make, model and year of vehicle being consolidated. The component parts are examined to determine which components are compatible with each vehicle by make, model, and year. Next, a database is constructed listing the parts of the AC system by how commonly they are used in vehicles, along with a list of the attributes of each part which determine whether a part is compatible with the vehicle. This list is used to sort vehicles into groups which share many parts in common, allowing them to be marketed as a single consolidated kit allowing repair of each vehicle.

Vehicles of different make, model, and year may be combined into a single kit if the components required to service their systems are similar. In the preferred embodiment, if candidate vehicles are not identical, consolidating vehicles which are identical or differ only in a small number of inexpensive parts is prioritized. In the preferred embodiment, this means that vehicles consolidated typically contain identical parts or differ only in the orifice tubes or seals used within by the system. This minimizes the redundant parts that customers must purchase in order to service any particular vehicle from the consolidated set.

The diagrams in accordance with exemplary embodiments of the present invention are provided as examples and should not be construed to limit other embodiments within the scope of the invention. For instance, heights, widths, and thicknesses may not be to scale and should not be construed to limit the invention to the particular proportions illustrated. Additionally some elements illustrated in the singularity may actually be implemented in a plurality. Further, some element illustrated in the plurality could actually vary in count. Further, some elements illustrated in one form could actually vary in detail. Further yet, specific numerical data values (such as specific quantities, numbers, categories, etc.) or other specific information should be interpreted as illustrative for discussing exemplary embodiments. Such specific information is not provided to limit the invention.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. An automotive air conditioning service kit consisting essentially of;
one or more expansion devices;
an accumulator or receiver dryer;
a lubricant oil; and
a rapid seal kit.

2. An automotive air conditioning service kit as described in claim 1, further consisting essentially of;
a measuring cup.

3. An automotive air conditioning service kit consisting essentially of a set of parts for servicing an air conditioner, wherein the kit may include one or more different versions of each part compatible with different vehicles, wherein the kit may include duplicate parts, wherein the set of parts consists essentially of;
one or more expansion devices;
an accumulator or receiver dryer;
a lubricant oil; and
a rapid seal kit.

4. An automotive air conditioning service kit as in claim 3 further consisting essentially of;
a measuring cup.

5. An automotive air conditioning service kit as in claim 3, further consisting essentially of packaging or labelling identifying a range of vehicles by make, model, and year for which the kit provides compatible parts for repair and maintenance.

6. A method of producing an an automotive air conditioning service kit consisting essentially of;
preparing a list of vehicles sorted by make model and year;
listing a set of a set of compatible parts for repair and maintenance of each vehicle's air conditioning system, wherein the list of compatible parts consists essentially of;
one or more expansion devices;
an accumulator or receiver dryer;
a lubricant oil; and
a rapid seal kit;
identifying a plurality of vehicles which have a set of shared parts in common; and
producing a consolidated kit containing the set of shared parts, wherein the consolidated kit consists essentially of;
one or more expansion devices;
an accumulator or receiver dryer;
a lubricant oil; and
a rapid seal kit.

7. An automotive air conditioning service kit as in claim 6, wherein the list of compatible parts further consists essentially of;
a measuring cup; and
wherein the consolidated kit further consists essentially of;
a measuring cup.

8. An automotive air conditioning service kit as in claim 7, wherein the consolidated kit further consists essentially of;
packaging or labelling identifying a range of vehicles by make, model, and year for which the kit provides compatible parts for repair and maintenance.

9. An automotive air conditioning service kit as in claim 6, wherein the consolidated kit further consists essentially of;
packaging or labelling identifying a range of vehicles by make, model, and year for which the kit provides compatible parts for repair and maintenance.
